(19) United States
(12) Patent Application Publication
(10) Pub. No.: US 2026/0211272 A1
(43) Pub. Date: Jul. 23, 2026

(54) OPTICAL WAVEGUIDE ELEMENT, OPTICAL MODULATOR, AND OPTICAL TRANSMISSION DEVICE

(71) Applicant: SUMITOMO OSAKA CEMENT CO., LTD., Tokyo (JP)

(72) Inventors: Yuji Hayami, Tokyo (JP); Kosuke Okahashi, Tokyo (JP)

(21) Appl. No.: 19/140,842

(22) PCT Filed: Dec. 26, 2022
(86) PCT No.: PCT/JP2022/048045

§ 371 Date: Jun. 18, 2025

(51) Int. Cl. G02F 1/035

(52) U.S. Cl. CPC G02F 1/0356

(57) ABSTRACT

An optical waveguide element includes an optical waveguide that is disposed on a principal surface of an optical substrate; and a control electrode that controls a light wave propagating through the optical waveguide, the control electrode includes a first control electrode and a second control electrode that face each other on the principal surface of the optical substrate while interposing the optical waveguide, and each of those includes a common electrode that extends along the optical waveguide, a plurality of segment electrodes that are disposed closer to the optical waveguide than the common electrode and are divided along an extending direction of the optical waveguide, a plurality of connection electrodes that connect each of the plurality of segment electrodes to the common electrode, and an auxiliary electrode that extends in the extending direction of the optical waveguide and connects the adjacent connection electrodes to each other.

### TECHNICAL FIELD

The present invention relates to an optical waveguide element, an optical modulator, and an optical transmission device.

### BACKGROUND ART

In a high-speed and large-capacity optical fiber communication system, an optical modulator incorporating an optical modulation device as an optical waveguide element including an optical waveguide formed on a substrate and a control electrode for controlling light waves propagating in the optical waveguide is often used. As the optical waveguide elements that perform an optical modulation operation, a semiconductor optical modulation device using a semiconductor substrate such as an InP substrate and an LN optical modulation device using LiNbO₃ (hereinafter, also referred to as LN) for a substrate have been put to practical use.

The electrodes of an LN modulation device can be broadly classified into a signal electrode for propagating a radio frequency signal and applying a radio frequency electric field to the optical waveguide, and a bias electrode used for controlling a bias point (operation point). Since the bias point fluctuates due to the change over time or the change in the operating temperature, the bias point fluctuation amount, which is the fluctuation amount of the change, is one of the parameters that affect the performance of the LN optical modulator. The design of the bias electrode requires consideration of reduction of a control voltage and the bias point fluctuation amount.

Patent Literature No. 1 discloses a configuration in which an electric field is applied to an optical waveguide by a center electrode and a ground electrode facing each other while interposing the optical waveguide therebetween in a plane of an operation substrate, in which a conductor of a part of the ground electrode is removed. In this optical modulator, by removing the conductor of a part of the ground electrode, stress generated in the substrate due to a difference in linear expansion coefficient between the metal material of the ground electrode and the substrate is relaxed, and the bias point fluctuation amount accompanying the fluctuation of the operating temperature can be reduced.

On the other hand, due to the demand for the further miniaturization and the reduction in the drive voltage of the optical modulation device, it is necessary to narrow the inter-electrode gap (for example, the separation clearance between the center electrode and the ground electrode described above, which interpose the optical waveguide), and it is required that the electrode and the optical waveguide are disposed to be closer to each other. As a result, the stress generated in the substrate by the electrode due to the difference in linear expansion coefficients becomes greater than the stress in the related art and affects the bias point fluctuation amount.

As one means for reducing the substrate stress generated by the electrode, it is considered to narrow the line width of the electrode itself to reduce the area of the electrode disposed in the vicinity of the optical waveguide.

However, narrowing the line width of the electrode may affect the manufacturing yield of the optical waveguide element and may also affect the long-term reliability, due to the defect of the electrode pattern or the like during the formation of the electrode.

### CITATION LIST

### Patent Literature

Patent Literature 1: Japanese Laid-open Patent Publication No. 2009-098640

### SUMMARY OF INVENTION

### Technical Problem

From the above background, an object of the present invention is to reduce a bias point fluctuation of a drive voltage while improving a manufacturing yield and/or long-term reliability in an optical waveguide element.

### Solution to Problem

According to an aspect of the present invention, there is provided an optical waveguide element including: an optical waveguide that is disposed on a principal surface of an optical substrate; and a control electrode that controls a light wave propagating through the optical waveguide, in which the control electrode includes a first control electrode and a second control electrode that face each other on the principal surface of the optical substrate while interposing the optical waveguide, and each of the first control electrode and the second control electrode includes a common electrode that extends along the optical waveguide, a plurality of segment electrodes that are disposed closer to the optical waveguide than the common electrode and are divided along an extending direction of the optical waveguide, a plurality of connection electrodes that connect each of the plurality of segment electrodes to the common electrode, and an auxiliary electrode that extends in the extending direction of the optical waveguide and connects the adjacent connection electrodes to each other.

According to another aspect of the present invention, the optical waveguide element further includes a radio frequency electrode that is disposed on the optical substrate and performs a modulation operation by modulating the light wave propagating through the optical waveguide, in which the control electrode is a bias electrode that controls a bias point of the modulation operation.

According to another aspect of the present invention, a side of the auxiliary electrode facing the segment electrode is disposed at a position closer to the segment electrode than a position bisecting a distance between a side of the common electrode facing an optical waveguide side and a side of the segment electrode facing the optical waveguide side.

According to another aspect of the present invention, a side of the auxiliary electrode facing the segment electrode is disposed at a position closer to the common electrode than a position bisecting a distance between a side of the common electrode facing an optical waveguide side and a side of the segment electrode facing the optical waveguide side.

According to another aspect of the present invention, a side of the auxiliary electrode facing the segment electrode is disposed at a position bisecting a distance between a side of the common electrode facing an optical waveguide side and a side of the segment electrode facing the optical waveguide side.

According to another aspect of the present invention, a thickness of the segment electrode is equal to or less than 3 μm.

According to another aspect of the present invention, a width of the segment electrode measured in a direction orthogonal to the extending direction of the optical waveguide is narrower than a width of the auxiliary electrode.

According to another aspect of the present invention, a low elastic layer made of a low elastic material having an elastic modulus equal to or less than 1/10 of an elastic modulus of the common electrode is disposed between the control electrode and the optical substrate.

According to another aspect of the present invention, there is provided an optical modulator including: any of the optical waveguide elements which is an optical modulation device; a case that houses the optical waveguide element; an optical fiber that inputs light to the optical waveguide element; and an optical fiber that guides light output from the optical waveguide element to an outside of the case.

According to still another aspect of the present invention, there is provided an optical transmission device including: any of the optical modulators; and an electronic circuit that generates an electrical signal for causing the optical waveguide element to perform an optical modulation operation.

### Advantageous Effects of Invention

According to the present invention, in the optical waveguide element, it is possible to reduce the bias point fluctuation of the drive voltage while improving the manufacturing yield and/or the long-term reliability.

### BRIEF DESCRIPTION OF DRAWINGS

FIG. 1 is a diagram illustrating a configuration of an optical modulator according to a first embodiment of the present invention.

FIG. 2 is a diagram illustrating a configuration of an optical modulation device used in the optical modulator illustrated in FIG. 1.

FIG. 3 is a partial detailed view of a part A of a bias electrode portion illustrated in FIG. 2.

FIG. 4 is a partial detailed view of a part B of the bias electrode portion illustrated in FIG. 3.

FIG. 5 is a cross-sectional view taken along line V-V of a part B illustrated in FIG. 4.

FIG. 6 is a cross-sectional view taken along line VI-VI of the part B illustrated in FIG. 4.

FIG. 7 is a diagram illustrating a configuration of an optical modulation device according to a first modification example.

FIG. 8 is a diagram illustrating a configuration of an optical modulation device according to a second modification example.

FIG. 9 is a diagram illustrating a configuration of an optical modulation device according to a third modification example.

FIG. 10 is a diagram illustrating a configuration of an optical modulation device according to a fourth modification example.

FIG. 11 is a diagram illustrating a configuration of an optical modulation device according to a fifth modification example.

FIG. 12 is a diagram illustrating a configuration of an optical modulation device according to a sixth modification example.

FIG. 13 is a diagram illustrating a configuration of an optical modulation device according to the sixth modification example.

FIG. 14 is a diagram illustrating a configuration of an optical modulation device according to a seventh modification example.

FIG. 15 is a cross-sectional view taken along line XV-XV of a control electrode illustrated in FIG. 14.

FIG. 16 is a view illustrating a configuration of an optical transmission device according to a second embodiment of the present invention.

FIG. 17 is a view illustrating an example of a configuration in which the control electrode according to the embodiment of the present invention is applied to a bias electrode of a nested Mach-Zehnder type optical waveguide in FIG. 2.

### DESCRIPTION OF EMBODIMENTS

Hereinafter, embodiments of the present invention will be described with reference to the drawings.

### 1. First Embodiment

First, a first embodiment of the present invention will be described.

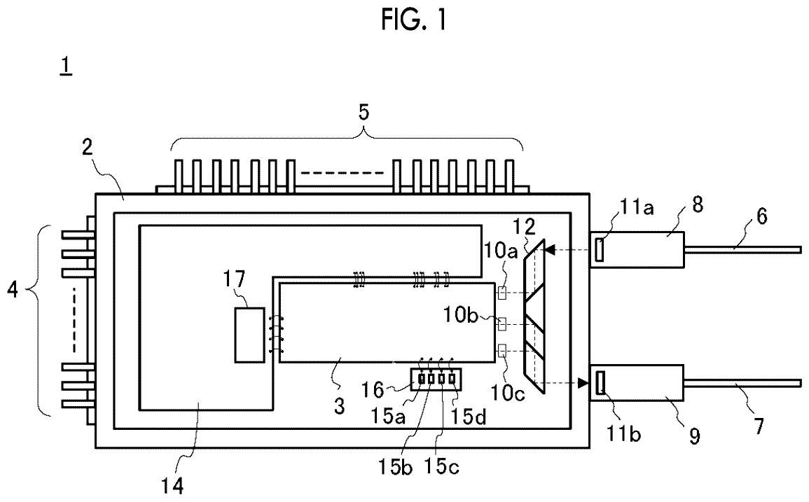

FIG. 1 is a diagram illustrating a configuration of an optical modulator 1 using an optical modulation device, which is an optical waveguide element according to a first embodiment of the present invention.

The optical modulator 1 includes a case 2, and an optical modulation device 3 housed in the case 2. The optical modulation device 3 is, for example, a configuration of a DP-QPSK modulator. The case 2 complies with, for example, the HB-CDM standard, which is an industry standard (“Implementation Agreement for the High Bandwidth Coherent Driver Modulator (HB-CDM) OIF-HB-CDM-02.0” (Jul. 15, 2021, published by OIF)). The inside of the case 2 is finally hermetically sealed with a plate-shaped cover (not shown) fixed to an opening portion of the case 2.

The case 2 is provided with a signal pin 4 for inputting a high-frequency electrical signal used for modulation of the optical modulation device 3 to a drive circuit 17 mounted on a relay board 14 described below. In addition, the case 2 is provided with a signal pin 5 for inputting an electrical signal used for adjusting an operation point of the optical modulation device 3, or the like for inputting a power supply for the operation of the drive circuit 17, and for inputting and outputting a control signal necessary for operating the drive circuit 17.

The optical modulator 1 includes an input optical fiber 6 for inputting light into the case 2 and an output optical fiber 7 for guiding the light modulated by the optical modulation device 3 to the outside of the case 2 on the same surface of the case 2. In addition, the optical modulator 1 includes a beam shifter 12 having both a beam shift function and a polarization combining function.

The input optical fiber 6 and the output optical fiber 7 are fixed to the case 2 via the supports 8 and 9 which are fixing members, respectively. Light input from the input optical fiber 6 is collimated by the lens 11a disposed in the support 8, passes through the beam shifter 12, and is input to the optical modulation device 3 via the lens 10a. However, this is only an example, and the input of light to the optical modulation device 3 may be performed by introducing, for example, the input optical fiber 6 into the case 2 via the support 8, and connecting the end surface of the introduced input optical fiber 6 to the end surface of an optical substrate 30 (described later) of the optical modulation device 3, according to the related art.

The two modulated light beams output from the optical modulation device 3 are collimated by the lenses 10b and 10c, respectively, and then are combined into one beam by the polarization combining function of the beam shifter 12. The combined beam is focused by the lens 11b disposed in the support 9 and is coupled to the output optical fiber 7.

The relay board 14 and a terminator 16 including four termination resistors 15a, 15b, 15c, and 15d having a predetermined impedance are disposed in the case 2 of the optical modulator 1. Hereinafter, the termination resistors 15a, 15b, 15c, and 15d will be collectively referred to as termination resistors 15. The electrical connection between the optical modulation device 3 and the termination resistor 15 of the terminator 16 is performed by, for example, wire bonding or the like.

The relay board 14 includes the drive circuit 17. The drive circuit 17 amplifies the high-frequency electrical signal input from the signal pin 4 and outputs a drive signal for causing the optical modulation device 3 to perform a modulation operation. In addition, the relay board 14 relays an electrical signal for adjusting an operation point and the like, a power supply, and a control signal, which are input from the signal pin 5, to the optical modulation device 3. The conductor pattern of the relay board 14 is connected to each solder (not shown) configuring one end of the electrode of the optical modulation device 3, for example, by wire bonding or the like. The relay board 14 is shown as one substrate in FIG. 1, but may be configured by being divided into a plurality of substrates as necessary. In addition, the drive circuit 17 may be mounted on the relay board 14 as illustrated in FIG. 1, or may be disposed between the relay board 14 and the optical modulation device 3. In addition, an interface used for inputting the high-frequency electrical signal may be a flexible printed circuit board (FPC) provided outside the case 2, instead of the signal pin 4.

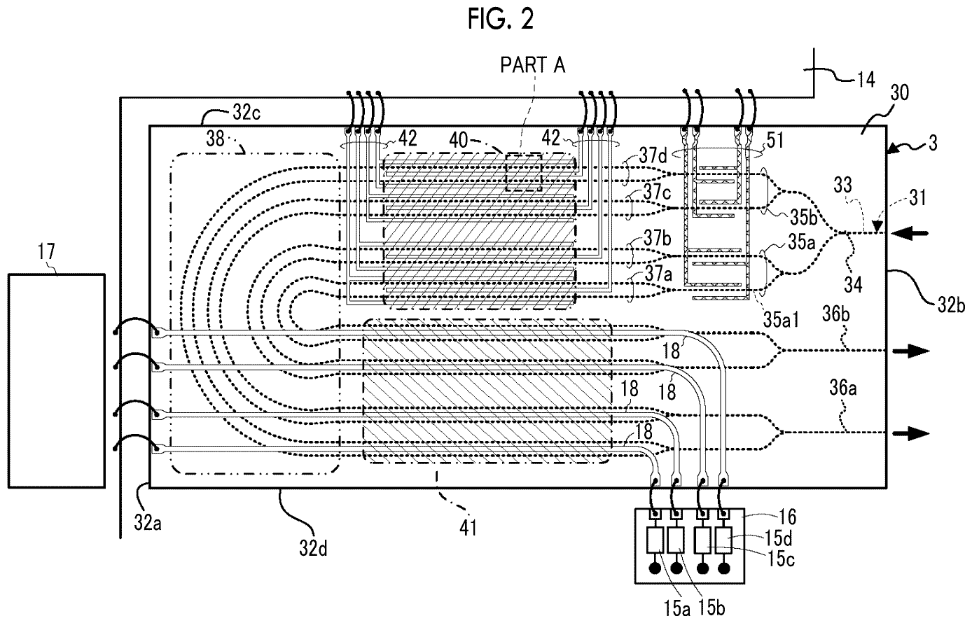

FIG. 2 is a diagram illustrating an example of a configuration of the optical modulation device 3, which is a DP-QPSK modulator or the like.

The optical modulation device 3 is configured with an optical waveguide 31 (the entire thick line and dotted line illustrated in the drawing) formed on one principal surface (surface illustrated in FIG. 2) of the optical substrate 30, and performs, for example, coherent multi-level modulation exceeding 100 GBaud. For example, the optical substrate 30 is an X-cut LN substrate that has an electro-optic effect and that is processed to have a thickness equal to or less than 20 μm (for example, 2 μm) to be formed as a thin film. The optical waveguide 31 is a protruding optical waveguide (for example, a rib-type optical waveguide or a ridge optical waveguide) including a strip-shaped extending protruding portion formed on the surface of the thinned optical substrate 30.

The optical substrate 30 is, for example, rectangular and has two sides 32a and 32b that are on left and right sides in the drawing, that extend in an up-down direction in the drawing, and that face each other, and sides 32c and 32d that are on upper and lower sides in the drawing, that extend in a left-right direction in the drawing, and that face each other.

The optical waveguide 31 includes an input waveguide 33 that receives the input light (arrow pointing to the right in the drawing) from the input optical fiber 6 on the upper side of the right side 32b in the drawing on the right side of the optical substrate 30 in the drawing, and a branched waveguide 34 that branches the input light into two light beams having the same light amount, in the drawing. Further, the optical waveguide 31 includes a so-called nested Mach-Zehnder type optical waveguides 35a and 35b, which are two modulation portions for modulating each light branched by the branched waveguide 34.

In the nested Mach-Zehnder type optical waveguides 35a and 35b, the propagation direction of light is folded by 180 degrees in the folded-back region 38 in the left portion of the optical substrate 30 in the drawing, and light is output to the right side in the drawing from the side 32b of the optical substrate 30 by the output waveguides 36a and 36b.

The nested Mach-Zehnder type optical waveguides 35a and 35b respectively include two Mach-Zehnder type optical waveguides 37a and 37b, and 37c and 37d respectively provided in two waveguide parts forming a pair of parallel waveguides.

In the RF electrode portion 41 in the lower portion of the nested Mach-Zehnder type optical waveguides 35a and 35b, which are folded back in the folded-back region 38, on the left portion of the optical substrate 30 in the drawing, four center electrodes 18 through which a high-frequency electrical signal propagates for performing the modulation operation on each of four Mach-Zehnder type optical waveguides 37a, 37b, 37c, and 37d configuring the nested Mach-Zehnder type optical waveguides 35a and 35b are disposed between two parallel waveguides of the corresponding Mach-Zehnder type optical waveguide 37.

In FIG. 2, each of the center electrodes 18 forms a distributed constant transmission line having a predetermined impedance together with a ground electrode (not shown) formed in accordance with the related art to sandwich the center electrodes 18 at positions separated by a certain distance from each other on the principal surface of the optical substrate 30.

As a result, the drive signals output from the drive circuit 17 are respectively input to the corresponding center electrodes 18 from the left side illustrated in FIG. 2, propagate as traveling waves to the respective center electrodes 18 to the right side in the drawing, and modulate the light wave propagating in the corresponding Mach-Zehnder type optical waveguide 37 in the RF electrode portion 41. Here, the center electrode 18 corresponds to a radio frequency electrode in the present disclosure.

In addition, on the bias electrode portion 40 of the nested Mach-Zehnder type optical waveguides 35a and 35b, which are folded back in the folded-back region 38, in the upper portion of the drawing, the control electrodes 42 are provided that are bias electrodes for compensating for bias point fluctuations due to a so-called DC drift of each of four Mach-Zehnder type optical waveguides 37a, 37b, 37c, and 37d of the nested Mach-Zehnder type optical waveguides 35a and 35b to adjust an operation point. In addition, bias electrodes 51 for adjusting the operation points of the nested Mach-Zehnder type optical waveguides 35a and 35b are also formed on the optical substrate 30.

Hereinafter, the Mach-Zehnder type optical waveguides 37a, 37b, 37c, and 37d will be collectively referred to as Mach-Zehnder type optical waveguides 37.

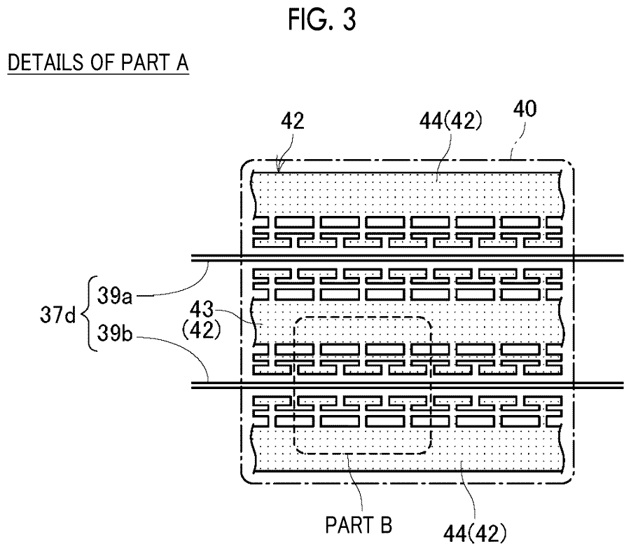

FIG. 3 is a partial detailed view of a part A in FIG. 2, and is a view illustrating an electrode configuration of the Mach-Zehnder type optical waveguide 37d in the bias electrode portion 40. The electrode configurations of the other Mach-Zehnder type optical waveguides 37a, 37b, and 37c in the bias electrode portion 40 are also the same as the electrode configuration of the Mach-Zehnder type optical waveguide 37d illustrated in FIG. 3. In FIG. 3, light is input from the right side of the drawing and is output to the left side of the drawing.

The control electrode 42, which is the bias electrode provided in the bias electrode portion 40, includes one first control electrode 43 and two second control electrodes 44. On the principal surface of the optical substrate 30, the first control electrode 43 is disposed between the parallel waveguides 39a and 39b of the Mach-Zehnder type optical waveguide 37d, which is a part of the optical waveguide 31. The two second control electrodes 44 are respectively disposed at positions facing the first control electrode 43 with the parallel waveguide 39a and 39b interposed therebetween.

Hereinafter, the parallel waveguide 39a and the parallel waveguide 39b will be collectively referred to as a parallel waveguide 39.

The first control electrode 43 and the second control electrode 44 are made of, for example, gold (Au), and chromium (Cr) may be used as a base metal to improve the adhesiveness to the optical substrate 30.

In FIG. 3, the first control electrode 43 actually extends to the right side of the drawing, receives one potential from the relay board 14, and the two second control electrodes 44 extend to the left side of the drawing and receive the other potential from the relay board 14.

The electric field generated between the first control electrode 43 and the two second control electrodes 44 controls the light waves propagating through the respective parallel waveguides 39, and the bias point of the modulation operation in the Mach-Zehnder type optical waveguide 37d is controlled.

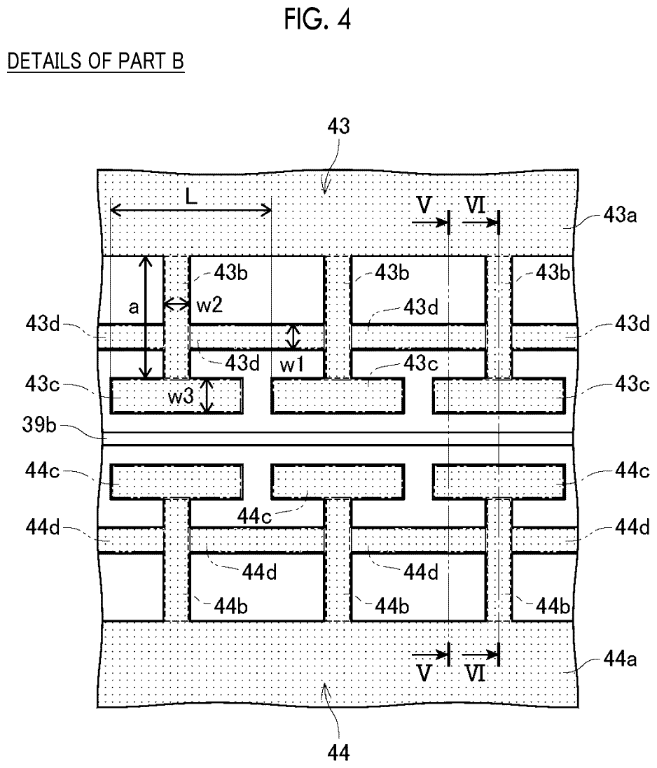

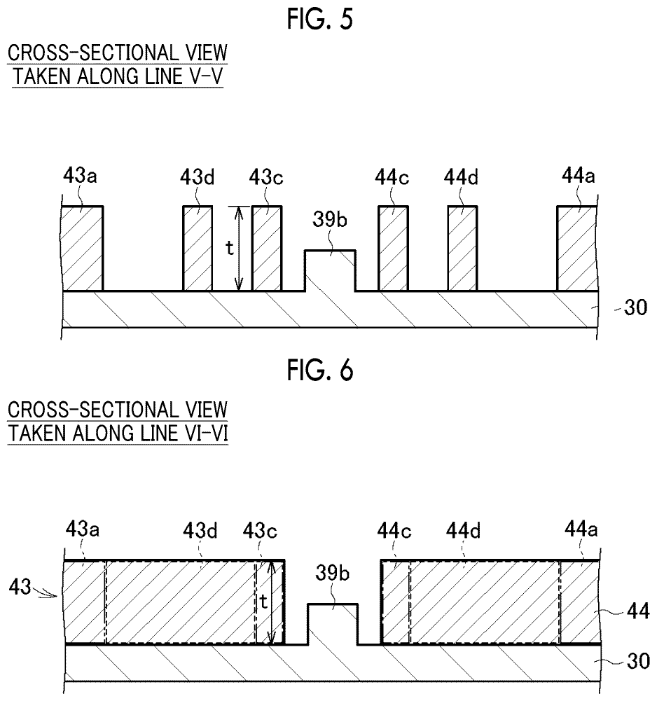

FIG. 4 is a partial detailed view of a part B of the bias electrode portion 40 illustrated in FIG. 3. In addition, FIG. 5 and FIG. 6 are cross-sectional views taken along a line V-V and a line VI-VI of the part B illustrated in FIG. 4.

In the B part illustrated in FIG. 4, one second control electrode 44 and one first control electrode 43 that face each other with one parallel waveguide 39b of the Mach-Zehnder type optical waveguide 37d interposed therebetween are shown. In FIG. 3, the other second control electrode 44 and the other first control electrode 43 that face each other with the other parallel waveguide 39a interposed therebetween are also configured in the same manner as in the configuration illustrated in FIG. 4.

As illustrated in FIG. 4, the first control electrode 43 includes a common electrode 43a that extends along the parallel waveguide 39b, and a plurality of segment electrodes 43c that are disposed closer to the parallel waveguide 39b than the common electrode 43a and are divided along the extending direction of the parallel waveguide 39b. In addition, the first control electrode 43 includes a plurality of connection electrodes 43b that connect each of the plurality of segment electrodes 43c to the common electrode 43a. In addition, the first control electrode 43 further includes an auxiliary electrode 43d that extends in the extending direction of the parallel waveguide 39b and connects the adjacent connection electrodes 43b to each other.

Similarly, the second control electrode 44 includes a common electrode 44a that extends along the parallel waveguide 39b to propagate a radio frequency signal, and a plurality of segment electrodes 44c that are disposed closer to the parallel waveguide 39b than the common electrode 44a and are divided along the extending direction of the parallel waveguide 39b. In addition, the second control electrode 44 includes a plurality of connection electrodes 44b that connect each of the plurality of segment electrodes 44c to the common electrode 44a. In addition, the second control electrode 44 further includes an auxiliary electrode 44d that extends in the extending direction of the parallel waveguide 39b and connects the adjacent connection electrodes 44b to each other.

Here, the auxiliary electrodes 43d and 44d can be disposed at any position where the adjacent connection electrodes 43b and 44b can be connected to each other.

As shown in FIGS. 5 and 6, in the present embodiment, each portion of the first control electrode 43 and the second control electrode 44 is directly formed on the optical substrate 30.

In the optical modulation device 3 having the above-described configuration, since the segment electrodes 43c and 44c disposed in the vicinity of the parallel waveguide 39 are divided along the extending direction of the parallel waveguide 39, substrate stress that can be generated in the vicinity portion of the parallel waveguide 39 in the optical substrate 30 can be reduced as compared with the bias electrodes which are not divided in the related art.

In addition, in the bias electrode that is not divided along the extending direction of the parallel waveguide 39 in the related art, in a case where a part of the bias electrode is defective, a state in which a bias voltage is not applied to most of the bias electrode may occur depending on a defect generation position. On the other hand, in the optical modulation device 3, the segment electrodes 43c and 44c are connected to the common electrodes 43a and 44a through the connection electrodes 43b and 44b, respectively. Therefore, even in a case where some of the segment electrodes 43c and 44c are defective, the bias voltage from the common electrodes 43a and 44a is normally supplied to the other segment electrodes 43c and 44c. Therefore, in the optical modulation device 3, even in a case where the line widths of the segment electrodes 43c and 44c are set to be narrow to reduce the bias point fluctuation amount, the manufacturing yield and the long-term reliability can be improved as compared with the optical modulation device using the bias electrodes which are not divided in the related art.

Furthermore, in the optical modulation device 3, the adjacent connection electrodes 43b and 44b are connected to the auxiliary electrodes 43d and 44d. Therefore, even in a case where there is a defect in the connection electrode 43b or 44b, the segment electrode 43c or 44c connected to the connection electrode 43b or 44b having the defect can receive the supply of the bias voltage from the adjacent connection electrode 43b or 44b. Therefore, in the optical modulation device 3, even in a case where the line widths of the connection electrodes 43b and 44b are further set to be narrow to reduce the bias point fluctuation amount, the manufacturing yield and the long-term reliability can be improved.

As described above, in the optical modulation device 3, the manufacturing yield and/or the long-term reliability can be improved, and the bias point fluctuation amount of the drive voltage can be reduced.

As the preferred sizes of the first control electrode 43 and the second control electrode 44, in the present embodiment, the lengths a (see FIG. 4) of the connection electrodes 43b and 44b from the common electrodes 43a and 44a to the segment electrodes 43c and 44c, respectively, are equal to or greater than 1 μm and equal to or less than 10 μm. In addition, the widths W1 of the auxiliary electrodes 43d and 44d and the widths W2 of the connection electrodes 43b and 44b are both equal to or greater than 1 μm and equal to or less than 10 μm. In addition, the width W3 of the segment electrodes 43c and 44c measured in a direction orthogonal to the extending direction of the parallel waveguide 39b is equal to or greater than 1 μm and equal to or less than 10 μm. In addition, the pitch L between the segment electrodes 43c and the pitch L between the segment electrodes 44c measured in the extending direction of the parallel waveguide 39b are equal to or greater than 50 μm and equal to or less than 500 μm.

In the present embodiment, the bias voltage is supplied from the common electrodes 43a and 44a to each of the segment electrodes 43c and 44c via the connection electrodes 43b and 44b and the auxiliary electrodes 43d and 44d. Therefore, even in a case where a conductor defect occurs in a part of the segment electrodes 43c and 44c, an adjustment operation of the bias point can be normally performed by the other segment electrodes 43c and 44c. Therefore, for example, the widths W3 of the segment electrodes 43c and 44c can be configured to be narrower than the widths W1 of the auxiliary electrodes 43d and 44d. As a result, the generation of the substrate stress in the vicinity of the parallel waveguide 39 is further suppressed, and the bias point fluctuation amount can be further reduced.

In addition, in the cross sections of FIGS. 5 and 6, the thickness t of the segment electrodes 43c and 44c is preferably equal to or less than 3 μm. As a result, the substrate stress in the vicinity of the parallel waveguide 39 is reduced, and the bias point fluctuation amount can be reduced.

Next, a modification example of the optical modulation device 3 as the optical waveguide element will be described.

### First Modification Example

In the first control electrode 43 and the second control electrode 44 illustrated in FIG. 4 described above, each of the connection electrodes 43b and 44b is connected to a central portion of each of the segment electrodes 43c and 44c in a length direction along the extending direction of the parallel waveguide 39. However, this is an example, and each of the connection electrodes 43b and 44b can be connected to any position of each of the segment electrodes 43c and 44c.

For example, each of the connection electrodes 43b and 44b may be connected to one end portion of each of the segment electrodes 43c and 44c in the length direction along the extending direction of the parallel waveguide 39.

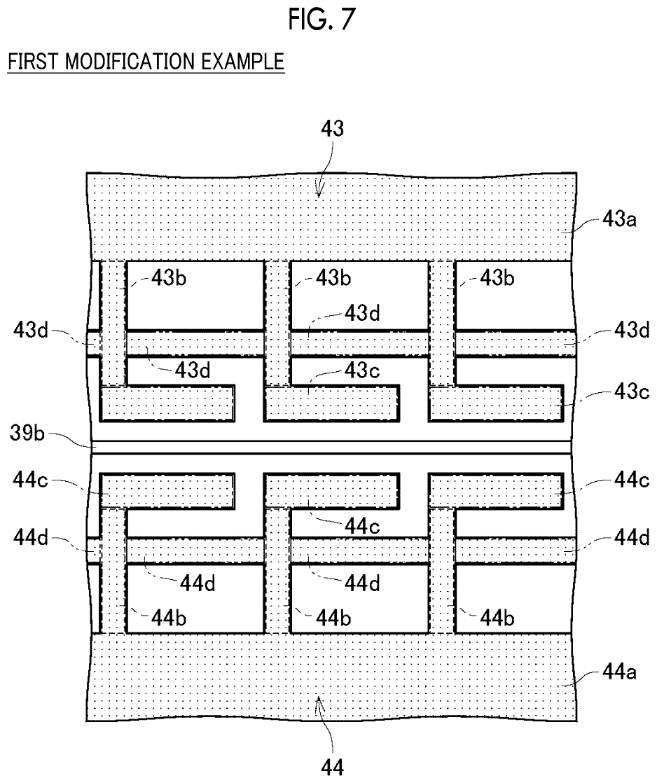

FIG. 7 is a diagram illustrating a configuration of the control electrode 42 of the optical modulation device 3 according to a first modification example. Here, FIG. 7 is a diagram corresponding to FIG. 4 described above. In the example illustrated in FIG. 7, each of the connection electrodes 43b and 44b is connected to the left end portion of each of the segment electrodes 43c and 44c in the drawing in the length direction along the extending direction of the parallel waveguide 39. The first control electrode 43 and the second control electrode 44 interposing the parallel waveguide 39a may also be configured in the same manner as described above.

### Second Modification Example

In the first control electrode 43 and the second control electrode 44 illustrated in FIG. 4, the positions of the auxiliary electrodes 43d and 44d are optional as long as the adjacent connection electrodes 43b and 44b can be connected to each other. However, the auxiliary electrodes 43d and 44d have different effects respectively depending on whether the auxiliary electrodes 43d and 44d are respectively disposed at positions close to the segment electrodes 43c and 44c or at positions close to the common electrodes 43a and 44a.

As a second modification example of the optical modulation device 3, for example, the auxiliary electrode 43d has a side facing the segment electrode 43c that is disposed at a position closer to the segment electrode 43c than a position bisecting a distance between a side of the common electrode 43a facing the parallel waveguide 39 side and a side of the segment electrode 43c facing the parallel waveguide 39 side. Similarly, the auxiliary electrode 44d has a side facing the segment electrode 44c that is disposed at a position closer to the segment electrode 44c than a position bisecting a distance between a side of the common electrode 44a facing the parallel waveguide 39 side and a side of the segment electrode 44c facing the parallel waveguide 39.

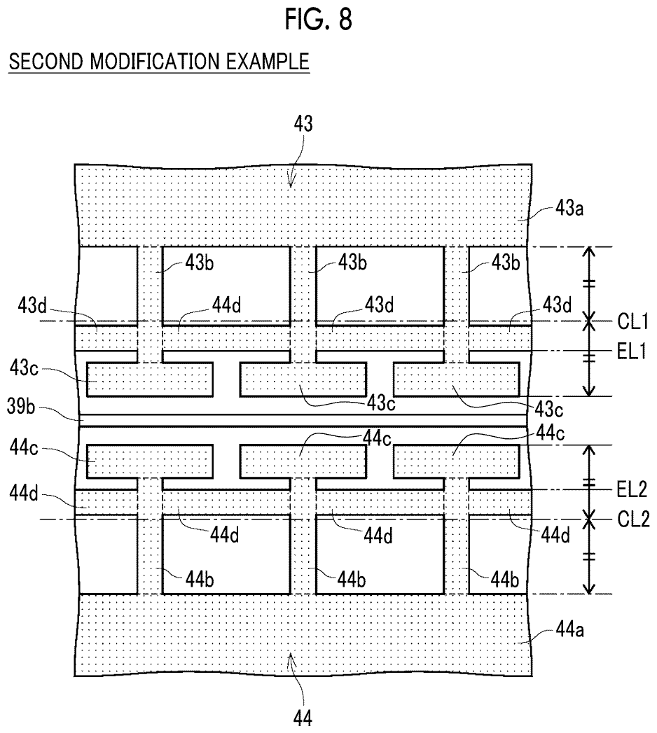

FIG. 8 is a diagram illustrating a configuration of the control electrode 42 of the optical modulation device 3 according to the second modification example. Here, FIG. 8 is a diagram corresponding to FIG. 4 described above. In FIG. 8, in order to simplify the drawing and facilitate understanding, only the boundary lines of the common electrode 43a, the connection electrode 43b, the segment electrode 43c, and the auxiliary electrode 43d are respectively shown by dotted lines in the first control electrode 43. The same applies to the second control electrode 44.

As illustrated in FIG. 8, the auxiliary electrode 43d is disposed at a position where a line EL1, which is an extension line of a side facing the segment electrode 43c, is closer to the segment electrode 43c than a line CL1 indicating a position bisecting a distance between a side of the common electrode 43a facing the parallel waveguide 39b side and a side of the segment electrode 43c facing the parallel waveguide 39b side. Similarly, the auxiliary electrode 44d is disposed at a position where a line EL2, which is an extension line of a side facing the segment electrode 44c, is closer to the segment electrode 44c than a line CL2 indicating a position bisecting a distance between a side of the common electrode 44a facing the parallel waveguide 39b side and a side of the segment electrode 44c facing the parallel waveguide 39b side. The first control electrode 43 and the second control electrode 44 interposing the parallel waveguide 39a may also be configured in the same manner as described above.

In general, the shorter the distance that the conductor pattern formed on the optical substrate 30 extends, the lower the probability of generation of the conductor defect or the like. That is, in the configuration illustrated in FIG. 8, in the first control electrode 43, the probability of generation of the conductor defect generating in a range from the connection portion with the auxiliary electrode 43d to the connection portion with the segment electrode 43c in the connection electrode 43b is lower than the probability of generation of the conductor defect generating in a range from the connection portion with the common electrode 43a to the connection portion with the auxiliary electrode 43d. Therefore, in the configuration illustrated in FIG. 8, the generation of the conductor defect in the connection electrode 43b is limited to a range from the connection portion with the common electrode 43a to the connection portion with the auxiliary electrode 43d, and the probability that a bypass path for electricity to the defect can be secured by the auxiliary electrode 43d is increased. The same applies to the second control electrode 44. As a result, in the configuration illustrated in FIG. 8, the manufacturing yield and the long-term reliability of the optical modulation device 3 can be further improved.

### Third Modification Example

As a third modification example of the optical modulation device 3, for example, the auxiliary electrode 43d has a side facing the segment electrode 43c that is disposed at a position closer to the common electrode 43a than a position bisecting a distance between a side of the common electrode 43a facing the parallel waveguide 39 side and a side of the segment electrode 43c facing the parallel waveguide 39 side. Similarly, the auxiliary electrode 44d has a side facing the segment electrode 44c that is disposed at a position closer to the common electrode 44a than a position bisecting a distance between a side of the common electrode 44a facing the parallel waveguide 39 side and a side of the segment electrode 44c facing the parallel waveguide 39 side.

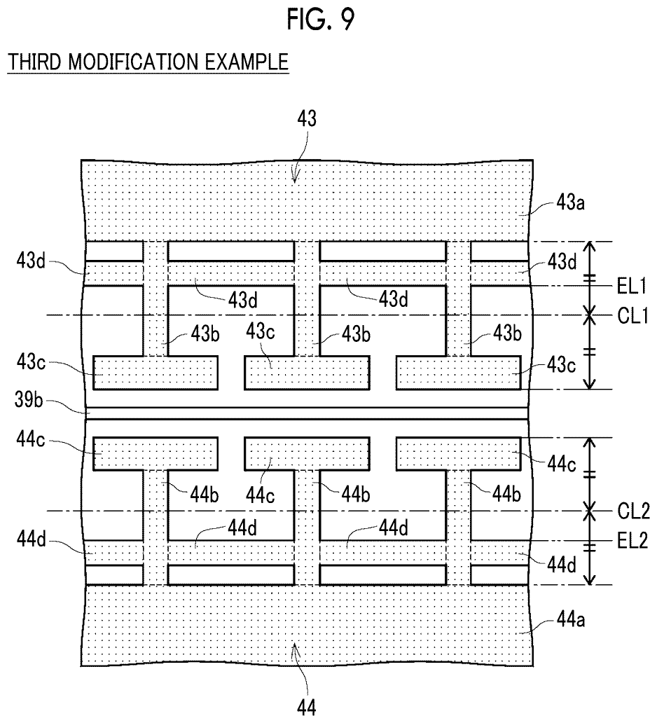

FIG. 9 is a diagram illustrating a configuration of the control electrode 42 of the optical modulation device 3 according to the third modification example. Here, FIG. 9 is a diagram corresponding to FIG. 4 described above. In FIG. 9, as in FIG. 8, only the boundary lines of the common electrode 43a, the connection electrode 43b, the segment electrode 43c, and the auxiliary electrode 43d are respectively shown by dotted lines in the first control electrode 43. The same applies to the second control electrode 44.

As illustrated in FIG. 9, the auxiliary electrode 43d is disposed at a position where a line EL1, which is an extension line of a side facing the segment electrode 43c, is closer to the common electrode 43a than a line CL1 indicating a position bisecting a distance between a side of the common electrode 43a facing the parallel waveguide 39b side and a side of the segment electrode 43c facing the parallel waveguide 39b side. Similarly, the auxiliary electrode 44d is disposed at a position where a line EL2, which is an extension line of a side facing the segment electrode 44c, is disposed closer to the common electrode 44a than a line CL2 indicating a position bisecting a distance between a side of the common electrode 44a facing the parallel waveguide 39b side and a side of the segment electrode 44c facing the parallel waveguide 39b side. The first control electrode 43 and the second control electrode 44 interposing the parallel waveguide 39a may also be configured in the same manner as described above.

In the configuration illustrated in FIG. 9, since the auxiliary electrodes 43d and 44d are formed closer to the common electrodes 43a and 44a and away from the segment electrodes 43c and 44c, respectively, substrate stress that may occur in the optical substrate 30 in the vicinity of the parallel waveguide 39 due to the auxiliary electrodes 43d and 44d can be reduced. Therefore, in the configuration illustrated in FIG. 9, the bias point fluctuation amount of the Mach-Zehnder type optical waveguide 37d can be further reduced.

### Fourth Modification Example

As a fourth modification example of the optical modulation device 3, for example, the auxiliary electrode 43d is disposed at a position where a side facing the segment electrode 43c bisects a distance between a side of the common electrode 43a facing the parallel waveguide 39 side and a side of the segment electrode 43c facing the parallel waveguide 39 side. Similarly, the auxiliary electrode 44d is disposed at a position where a side facing the segment electrode 44c bisects a distance between a side of the common electrode 44a facing the parallel waveguide 39 side and a side of the segment electrode 44c facing the parallel waveguide 39 side.

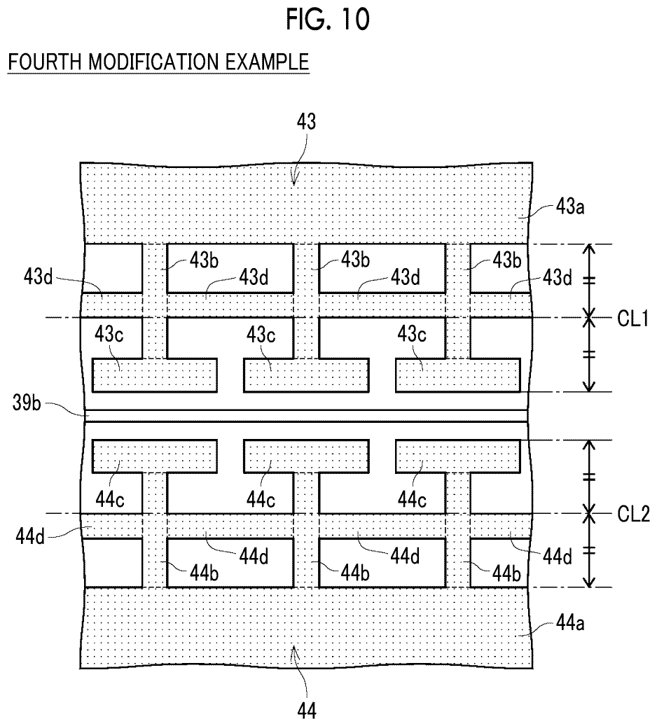

FIG. 10 is a diagram illustrating a configuration of the control electrode 42 of the optical modulation device 3 according to the fourth modification example. Here, FIG. 10 is a diagram corresponding to FIG. 4 described above. In FIG. 10, as in FIG. 8, only the boundary lines of the common electrode 43a, the connection electrode 43b, the segment electrode 43c, and the auxiliary electrode 43d are respectively shown by dotted lines in the first control electrode 43. The same applies to the second control electrode 44.

As illustrated in FIG. 10, the auxiliary electrode 43d is disposed at the same position as a line CL1 indicating a position where a side facing the segment electrode 43c bisects a distance between a side of the common electrode 43a facing the parallel waveguide 39b side and a side of the segment electrode 43c facing the parallel waveguide 39b side. Similarly, the auxiliary electrode 44d is disposed at a position where a line EL2, which is an extension line of a side facing the segment electrode 44c, is the same as a line CL2 indicating a position bisecting a distance between a side of the common electrode 44a facing the parallel waveguide 39b side and a side of the segment electrode 44c facing the parallel waveguide 39b side. The first control electrode 43 and the second control electrode 44 interposing the parallel waveguide 39a may also be configured in the same manner as described above.

In the configuration illustrated in FIG. 10, the effect of improving the manufacturing yield and the long-term reliability of the configuration of FIG. 8 according to the second modification example and the effect of reducing the bias point fluctuation amount of the configuration of FIG. 9 according to the third modification example can be exhibited in a well-balanced manner.

### Fifth Modification Example

The segment electrode 43c of the first control electrode 43 and the segment electrode 44c of the second control electrode 44, which face each other while interposing the parallel waveguide 39, may not be configured to be line-symmetrical with respect to the parallel waveguide 39 as illustrated in FIG. 4.

For example, as a fifth modification example of the optical modulation device 3, the segment electrode 44c of the second control electrode 44 is disposed at a position shifted along the extending direction of the parallel waveguide 39 with respect to the segment electrode 43c of the first control electrode 43 from a position that is line-symmetrical with respect to the parallel waveguide 39.

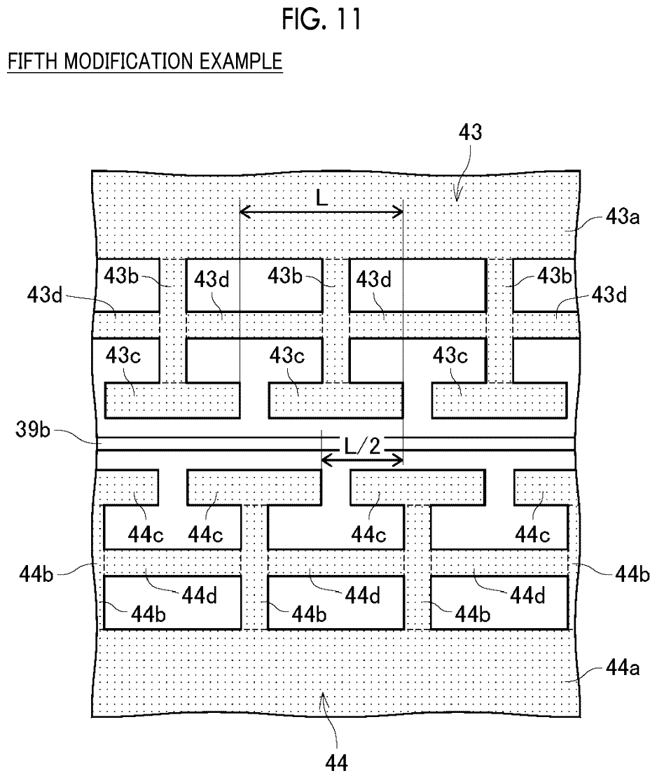

FIG. 11 is a diagram illustrating a configuration of the control electrode 42 of the optical modulation device 3 according to the fifth modification example. Here, FIG. 11 is a diagram corresponding to FIG. 4 described above. In the example illustrated in FIG. 11, the segment electrode 44c of the second control electrode 44 is disposed at a position shifted by a distance L/2 with respect to the segment electrode 43c of the first control electrode 43 from a position that is line-symmetrical with respect to the parallel waveguide 39 along the extending direction of the parallel waveguide 39. Here, Lis a disposition pitch between the segment electrodes 43c and between the segment electrodes 44c.

### Sixth Modification Example

As a sixth modification example of the optical modulation device 3, a low elastic layer made of a low elastic material having an elastic modulus which is equal to or less than 1/10 of the elastic modulus of the control electrode 42 can be disposed between the control electrode 42 and the optical substrate 30. As the low elastic material configuring a low elastic layer 45, for example, a resin can be used.

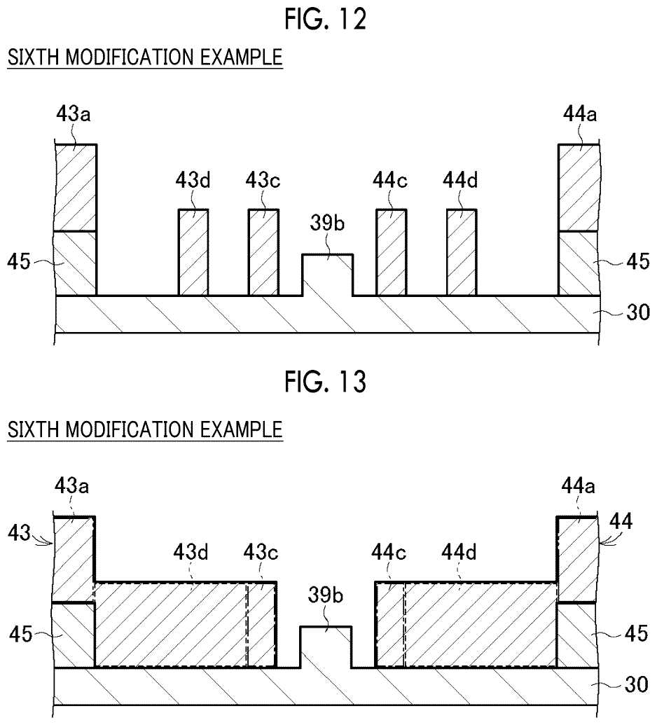

FIGS. 12 and 13 are diagrams illustrating a configuration of the optical modulation device 3 according to the sixth modification example. Here, FIGS. 12 and 13 are diagrams corresponding to FIGS. 5 and 6 described above. In FIGS. 12 and 13, as an example, the low elastic layer 45 having the above-described elastic modulus is formed on the principal surface of the optical substrate 30, and the common electrodes 43a and 44a are formed on the low elastic layer 45.

As a result, in the optical modulation device 3 according to the sixth modification example, the substrate stress generated at the boundary portion between the control electrode 42 and the optical substrate 30 can be relaxed, and the bias point fluctuation amount can be further reduced.

In the examples shown in FIGS. 12 and 13, the low elastic layer 45 is disposed below the common electrodes 43a and 44a, but the present invention is not limited to the disposition, and the low elastic layer 45 can be disposed below the entire or any part of the control electrode 42. For example, the low elastic layer 45 can be disposed not only below the common electrodes 43a and 44a but also below the entire or a part of each of the connection electrodes 43b and 44b.

However, from the viewpoint of effectively applying the electric field from the control electrode 42 to the parallel waveguide 39, it is desirable that the low elastic layer 45 is not provided below the segment electrodes 43c and 44c. In addition, from the viewpoint of ensuring the reliability of the supply of a voltage from the common electrodes 43a and 44a to the segment electrodes 43c and 44c, it is desirable that the adhesion strength between the auxiliary electrodes 43d and 44d and the optical substrate 30 is ensured while the low elastic layer 45 is not provided below the auxiliary electrodes 43d and 44d.

### Seventh Modification Example

As a seventh modification example of the optical modulation device 3, the low elastic layer 45 shown in the sixth modification example has one or more penetrating holes extending in the thickness direction of the low elastic layer 45, and the control electrode 42 is configured to extend to the principal surface of the optical substrate through the penetrating holes.

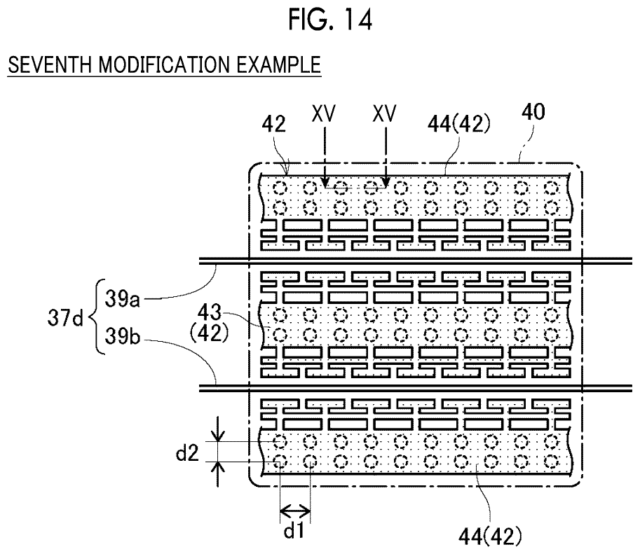

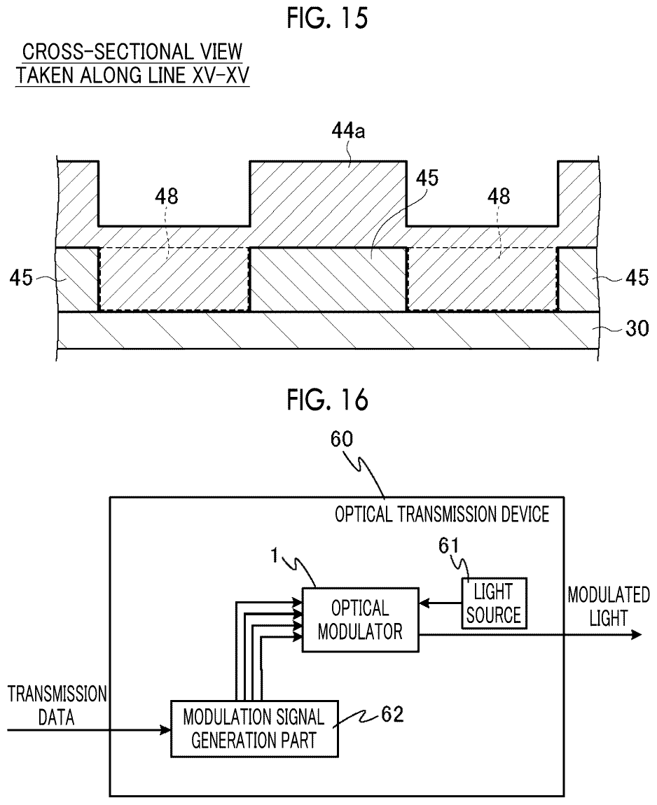

FIGS. 14 and 15 are diagrams illustrating a configuration of the optical modulation device 3 according to the seventh modification example. Here, FIG. 14 is a diagram corresponding to FIG. 3 described above. In addition, FIG. 15 is a cross-sectional view taken along line XV-XV in FIG. 14. In the example illustrated in FIG. 14, a plurality of penetrating holes 48 (circular dotted lines in the drawing) having a circular shape in a plan view are arranged in a matrix in the low elastic layer 45 disposed below each of the common electrode 43a of the first control electrode 43 and the common electrode 44a of the second control electrode 44. In FIG. 14, reference numeral is assigned to only one penetrating hole 48 as an example, but all the plurality of circular dotted lines indicate the penetrating holes 48.

Then, as illustrated in FIG. 15, for example, the common electrode 44a of the second control electrode 44 extends to the principal surface of the optical substrate 30 through the inside of the penetrating hole 48 (rectangular dotted line in the drawing). As in FIG. 15, the common electrode 43a of the first control electrode 43 also extends to the principal surface of the optical substrate 30 through the inside of the penetrating hole 48.

As a result, the control electrode 42 is directly in contact with the optical substrate 30 through the inside of the penetrating hole 48, and thus, for example, even in a case where the low elastic layer 45 is formed of a resin, the adhesiveness between the control electrode 42 and the optical substrate 30 can be increased, and the reliability of the optical modulation device 3 can be improved.

From the viewpoint of ensuring the adhesiveness between the control electrode 42 and the optical substrate 30, for example, the penetrating hole 48 preferably has a diameter r (see FIG. 14) which is equal to or greater than 1 μm and equal to or less than 25 μm. In addition, from the same viewpoint, the arrangement clearances d1 and d2 of the penetrating holes 48 in the extending direction of the parallel waveguide 39 and a direction orthogonal to the extending direction are preferably equal to or greater than 50 μm and equal to or less than 500 μm.

The penetrating hole 48 is not limited to a circular shape and can have any plan view shape. In this case, it is desirable that the penetrating hole 48 is configured such that the opening area on the optical substrate 30 side is approximately equal to the opening area of the penetrating hole having a circular shape in a plan view and a diameter which is equal to or greater than 1 μm and equal to or less than 25 μm. In addition, the penetrating hole 48 is not limited to a matrix shape and may be arranged in any regular pattern or irregular pattern. Even in this case, the arrangement clearance between the penetrating holes 48 is preferably equal to or greater than 50 μm and equal to or less than 500 μm.

### Second Embodiment

Next, a second embodiment of the present invention will be described. The present embodiment is an optical transmission device 60 equipped with the optical modulator 1 according to the first embodiment or the modification example of the first embodiment. FIG. 16 is a diagram illustrating a configuration of the optical transmission device 60 according to the present embodiment. The optical transmission device 60 includes an optical modulator 1, a light source 61, and a modulation signal generation part 62. The modulation signal generation part 62 is an electronic circuit that generates a radio frequency signal (modulation signal) for causing the optical modulator 1 to perform a modulation operation. The modulation signal generation part 62 generates, for example, four modulation signals for input to the optical modulation device 3 included in the optical modulator 1 based on transmission data given from the outside, and inputs the four modulation signals to the signal pins 4 of the optical modulator 1. In this way, the optical modulator 1 modulates light from the light source 61, which is input from the input optical fiber 6, and outputs the modulated light via the output optical fiber 7.

In the optical transmission device 60 having the above-described configuration, since the above-described optical modulator 1 in which the manufacturing yield and the long-term reliability are improved while reducing the bias point fluctuation amount is used, an optical transmission device having high transmission quality can be realized at low cost.

### Other Embodiments

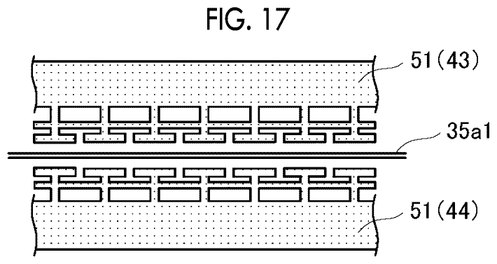

In the configuration illustrated in FIG. 2, the bias electrode 51 for adjusting the operation points of the nested Mach-Zehnder type optical waveguides 35a and 35b can also be configured in the same manner as the control electrode 42 illustrated in FIG. 4. FIG. 17 is a view illustrating an example of a bias electrode 51 configured in the same manner as the control electrode 42. In the example shown in the drawing, the two bias electrodes 51 interposing one parallel waveguide 35al (see FIG. 2) of the nested Mach-Zehnder type optical waveguide 35a are configured in the same manner as the first control electrode 43 and the second control electrode 44, respectively.

In the first embodiment or the modification example of the first embodiment described above, the bias electrode portion 40 is disposed upstream of the RF electrode portion 41 along the propagation direction of light in the optical waveguide 31, but may be disposed downstream of the RF electrode portion 41 depending on the mode of disposing the optical waveguide on the optical substrate 30 (for example, in a configuration not including the folded-back region 38). In addition, the two bias electrode portions 40 may be disposed at positions interposing the RF electrode portion 41 along the propagation direction of light in the optical waveguide 31.

Various modification examples in the first embodiment described above can be optionally combined to configure one optical waveguide element (for example, the optical modulation device 3). For example, the L-shaped electrode configuration in a plan view, which is configured by each of the segment electrode 43c and the connection electrode 43b and the segment electrode 43c and the connection electrode 43b, as shown in the first modification example, can be combined and applied to all other modification examples. In addition, for example, the configurations of the sixth modification example and the seventh modification example can be combined with all other modification examples.

In addition, the optical waveguide element in the present disclosure is not limited to the optical modulation device 3 that performs an optical modulation operation using a nested Mach-Zehnder type optical waveguide, and may be various optical waveguide elements that realize any function using an optical waveguide formed in any pattern. For example, the optical waveguide element may be configured to realize a function such as optical switching, including not only a Mach-Zehnder type optical waveguide but also a directional coupler type waveguide, a Y-branch waveguide, and the like.

The present invention is not limited to the configuration of the above embodiment and its alternative configuration, and can be implemented in various aspects without departing from the gist of the present invention.

### Configurations Supported by Embodiments

The above embodiments and modification examples support the following configurations.
(Configuration 1) An optical waveguide element including: an optical waveguide that is disposed on a principal surface of an optical substrate; and a control electrode that controls a light wave propagating through the optical waveguide, in which the control electrode includes a first control electrode and a second control electrode that face each other on the principal surface of the optical substrate while interposing the optical waveguide, and each of the first control electrode and the second control electrode includes a common electrode that extends along the optical waveguide, a plurality of segment electrodes that are disposed closer to the optical waveguide than the common electrode and are divided along an extending direction of the optical waveguide, a plurality of connection electrodes that connect each of the plurality of segment electrodes to the common electrode, and an auxiliary electrode that extends in the extending direction of the optical waveguide and connects the adjacent connection electrodes to each other.

According to the optical waveguide element of Configuration 1, a voltage is supplied from the common electrode to each of the segment electrodes via the connection electrode and the auxiliary electrode. Therefore, even in a case where the line width of the segment electrode is narrow and a conductor defect occurs in a part of the segment electrodes, the light wave propagating through the optical waveguide can be normally controlled by the other segment electrodes. Therefore, according to the optical waveguide element of Configuration 1, the manufacturing yield and the long-term reliability as the optical waveguide element can be improved while reducing the bias point fluctuation amount by forming the segment electrode in a thin manner.
(Configuration 2) The optical waveguide element of Configuration 1, further including a radio frequency electrode that is disposed on the optical substrate and performs a modulation operation by modulating the light wave propagating through the optical waveguide, in which the control electrode is a bias electrode that controls a bias point of the modulation operation.

According to the optical waveguide element of Configuration 2, in the bias electrode having a high degree of freedom in design in general as compared with the radio frequency electrode configured as the radio frequency transmission line, the bias point fluctuation can be reduced by configuring the electrode line width to be narrow.
(Configuration 3) The optical waveguide element of Configuration 1 or 2, in which a side of the auxiliary electrode facing the segment electrode is disposed at a position closer to the segment electrode than a position bisecting a distance between a side of the common electrode facing an optical waveguide side and a side of the segment electrode facing the optical waveguide side.

According to the optical waveguide element of Configuration 3, the generation of the conductor defect in the connection electrode is limited to a range from the common electrode to the auxiliary electrode, and the probability that a bypass path for electricity to the defect can be secured by the auxiliary electrode is increased. Therefore, according to the optical waveguide element of Configuration 3, the manufacturing yield and the long-term reliability of the optical waveguide element can be further improved.
(Configuration 4) The optical waveguide element of Configuration 1 or 2, in which a side of the auxiliary electrode facing the segment electrode is disposed at a position closer to the common electrode than a position bisecting a distance between a side of the common electrode facing an optical waveguide side and a side of the segment electrode facing the optical waveguide side.

According to the optical waveguide element of Configuration 4, since the auxiliary electrode is formed closer to the common electrode and away from the segment electrode, it is possible to reduce substrate stress that may be generated in the optical substrate in the vicinity of the optical waveguide due to the auxiliary electrode. Therefore, according to the optical waveguide element of Configuration 4, the bias point fluctuation amount can be further reduced.
(Configuration 5) The optical waveguide element of Configuration 1 or 2, in which a side of the auxiliary electrode facing the segment electrode is disposed at a position bisecting a distance between a side of the common electrode facing an optical waveguide side and a side of the segment electrode facing the optical waveguide side.

According to the optical waveguide element of Configuration 5, the effect of improving the manufacturing yield and the long-term reliability and the effect of reducing the bias point fluctuation amount can be exhibited in a well-balanced manner.
(Configuration 6) The optical waveguide element of any one of Configurations 1 to 5, in which a thickness of the segment electrode is equal to or less than 3 μm.

According to the optical waveguide element of Configuration 6, the substrate stress in the vicinity of the optical waveguide can be reduced, and thus the bias point fluctuation amount can be reduced.
(Configuration 7) The optical waveguide element of any one of Configurations 1 to 6, in which a width of the segment electrode measured in a direction orthogonal to the extending direction of the optical waveguide is narrower than a width of the auxiliary electrode.

According to the optical waveguide element of Configuration 7, the generation of substrate stress in the vicinity of the optical waveguide is further suppressed, and the bias point fluctuation amount can be further reduced.
(Configuration 8) The optical waveguide element of any one of Configurations 1 to 7, in which a low elastic layer made of a low elastic material having an elastic modulus equal to or less than 1/10 of an elastic modulus of the common electrode is disposed between the control electrode and the optical substrate.

According to the optical waveguide element of Configuration 8, the substrate stress generated at the boundary portion between the control electrode and the optical substrate can be relaxed, and the bias point fluctuation amount can be further reduced.
(Configuration 9) An optical modulator including: the optical waveguide element of any one of Configurations 1 to 8, which is an optical modulation device; a case that houses the optical waveguide element; an optical fiber that inputs light to the optical waveguide element; and an optical fiber that guides light output from the optical waveguide element to an outside of the case.

According to the optical modulator of Configuration 9, the bias point fluctuation of the drive voltage can be reduced while improving the manufacturing yield and/or the long-term reliability.
(Configuration 10) An optical transmission device including: the optical modulator of Configuration 9; and an electronic circuit that generates an electrical signal for causing the optical waveguide element to perform an optical modulation operation.

According to the optical transmission device of Configuration 10, since the optical modulator in which the bias point fluctuation of the drive voltage is reduced while improving the manufacturing yield and/or the long-term reliability is used, the optical transmission device having high transmission quality can be realized at low cost.

### REFERENCE SIGNS LIST

1 Optical modulator
2 Case
3 Optical modulation device
4, 5 Signal pin
6 Input optical fiber
7 Output optical fiber
8, 9 Support
10a, 10b, 10c, 11a, 11b Lens
12 Beam shifter
14 Relay board
15, 15a, 15b, 15c, 15d Termination resistor
16 Terminator
17 Drive circuit
18 Center electrode
30 Optical substrate
31 Optical waveguide
32a, 32b, 32c, 32d Side
33 Input waveguide
34 Branched waveguide
35, 35a, 35b Nested Mach-Zehnder type optical waveguide
36a, 36b Output waveguide
37a, 37b, 37c, 37d Mach-Zehnder type optical waveguide
38 Folded-back region
39a, 39b Parallel waveguide
40, 40a, 40b Bias electrode portion
41 RF electrode portion
42 Control electrode
43 First control electrode
44 Second control electrode
43a, 44a Common electrode
43b, 44b Connection electrode
43c, 44c Segment electrode
43d, 44d Auxiliary electrode
45 Low elastic layer
48 Penetrating hole
49 R portion
51 Bias electrode
60 Optical transmission device
61 Light source
62 Modulation signal generation part

1. An optical waveguide element comprising:
an optical waveguide that is disposed on a principal surface of an optical substrate; and
a control electrode that controls a light wave propagating through the optical waveguide,
wherein the control electrode includes a first control electrode and a second control electrode that face each other on the principal surface of the optical substrate while interposing the optical waveguide, and
each of the first control electrode and the second control electrode includes
a common electrode that extends along the optical waveguide,
a plurality of segment electrodes that are disposed closer to the optical waveguide than the common electrode and are divided along an extending direction of the optical waveguide,
a plurality of connection electrodes that connect each of the plurality of segment electrodes to the common electrode, and
an auxiliary electrode that extends in the extending direction of the optical waveguide and connects the adjacent connection electrodes to each other.

2. The optical waveguide element according to claim 1, further comprising:
a radio frequency electrode that is disposed on the optical substrate and performs a modulation operation by modulating the light wave propagating through the optical waveguide,
wherein the control electrode is a bias electrode that controls a bias point of the modulation operation.

3. The optical waveguide element according to claim 1,
wherein a side of the auxiliary electrode facing the segment electrode is disposed at a position closer to the segment electrode than a position bisecting a distance between a side of the common electrode facing an optical waveguide side and a side of the segment electrode facing the optical waveguide side.

4. The optical waveguide element according to claim 1,
wherein a side of the auxiliary electrode facing the segment electrode is disposed at a position closer to the common electrode than a position bisecting a distance between a side of the common electrode facing an optical waveguide side and a side of the segment electrode facing the optical waveguide side.

5. The optical waveguide element according to claim 1,
wherein a side of the auxiliary electrode facing the segment electrode is disposed at a position bisecting a distance between a side of the common electrode facing an optical waveguide side and a side of the segment electrode facing the optical waveguide side.

6. The optical waveguide element according to claim 1,
wherein a thickness of the segment electrode is equal to or less than 3 μm.

7. The optical waveguide element according to claim 1,
wherein a width of the segment electrode measured in a direction orthogonal to the extending direction of the optical waveguide is narrower than a width of the auxiliary electrode.

8. The optical waveguide element according to claim 1,
wherein a low elastic layer made of a low elastic material having an elastic modulus equal to or less than 1/10 of an elastic modulus of the common electrode is disposed between the control electrode and the optical substrate.

9. An optical modulator comprising:
the optical waveguide element according to claim 1, which is an optical modulation device;
a case that houses the optical waveguide element;
an optical fiber that inputs light to the optical waveguide element; and
an optical fiber that guides light output from the optical waveguide element to an outside of the case.

10. An optical transmission device comprising:
the optical modulator according to claim 9; and
an electronic circuit that generates an electrical signal for causing the optical waveguide element to perform an optical modulation operation.
